(19) United States
(12) Patent Application Publication
(10) Pub. No.: US 2023/0269628 A1
(43) Pub. Date: Aug. 24, 2023

(54) CONTROL DEVICE, COMMUNICATION SYSTEM, AND CONTROL METHOD

(71) Applicant: Panasonic Holdings Corporation, Osaka (JP)

(72) Inventor: Noriyuki GEJOH, Tokyo (JP)

(21) Appl. No.: 18/007,072

(22) PCT Filed: Jul. 27, 2021
(86) PCT No.: PCT/JP2021/027721

§ 371 Date: Jan. 27, 2023

(30) Foreign Application Priority Data
Aug. 5, 2020 (JP) 2020-132990

(51) Int. Cl. H04W 28/18

(52) U.S. Cl. CPC H04W 28/18

(57) ABSTRACT

This invention contributes to the provision of a control device, a communication system, and a control method by which a parameter relating to wireless communication can be easily controlled, in accordance with a change in the wireless communication environment. The control device comprises: an acquisition unit that acquires, for each of a plurality of terminals, a reception result indicating the result of reception processing with respect to a signal transmitted from each terminal; and a control unit that performs centralized control of the plurality of terminals, that performs machine learning common to the plurality of terminals on the basis of the reception results, and that determines a wireless communication-related parameter used by each of the plurality of terminals.

### TECHNICAL FIELD

The present disclosure relates to a control apparatus, a communication system, and a control method.

### BACKGROUND ART

Unlicensed bands may be utilized for communication between radio communication apparatuses (for example, between a base station and a terminal). Since unlicensed bands are utilized by various radio systems, various changes in a radio communication environment occur, which include interference and the like.

For example, Patent Literature (hereinafter referred to as “PTL”) 1 discloses a radio communication system that determines channel assignment such that the amount of interference is minimized in a case where channels to be used for communication are assigned to a plurality of base stations.

### CITATION LIST

### Patent Literature

### PTL 1

Japanese Patent Application Laid-Open No. 2013-81089

### SUMMARY OF INVENTION

However, there is room for consideration on a method of controlling a radio communication-related parameter of a channel or the like, which is used by a terminal, in accordance with a change in a radio communication environment.

One non-limiting and exemplary embodiment facilitates providing a control apparatus, a communication system, and a control method each capable of easily controlling a radio communication-related parameter in accordance with a change in a radio communication environment.

A control apparatus according to an exemplary embodiment of the present disclosure includes: an acquirer that acquires a reception result for each of a plurality of terminals, where the reception result indicates a result of reception processing on a signal transmitted from a corresponding one of the plurality of terminals; and a controller that performs centralized control of the plurality of terminals. The controller performs machine learning common to the plurality of terminals based on at least one of a plurality of the reception results and determines a radio communication-related parameter used by each of the plurality of terminals.

A communication system according to an exemplary embodiment of the present disclosure includes: a plurality of terminals; and a control apparatus that performs centralized control of the plurality of terminals. The control apparatus includes: an acquirer that acquires a reception result for each of the plurality of terminals, where the reception result indicates a result of reception processing on a first signal transmitted from a corresponding one of the plurality of terminals; and a first controller that performs machine learning common to the plurality of terminals based on at least one of a plurality of the reception results and determines a radio communication-related parameter used by each of the plurality of terminals. Each of the plurality of terminals includes: a receiver that receives control information including the radio communication-related parameter from the control apparatus; a second controller that performs transmission processing on a second signal by using the radio communication-related parameter; and a transmitter that transmits the second signal.

A control method according to an exemplary embodiment of the present disclosure includes: acquiring, by a controller that performs centralized control of a plurality of terminals, a reception result for each of the plurality of terminals, where the reception result indicates a result of reception processing on a signal transmitted from a corresponding one of the plurality of terminals; and performing, by the controller, machine learning common to the plurality of terminals based on at least one of a plurality of the reception results and determining a radio communication-related parameter used by each of the plurality of terminals.

It should be noted that general or specific embodiments may be implemented as a system, an apparatus, a method, an integrated circuit, a computer program, a storage medium, or any selective combination thereof.

According to an exemplary embodiment of the present disclosure, it is possible to easily control a radio communication-related parameter in accordance with a change in a radio communication environment.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an outline of radio systems including LPWA;

FIG. 2 is a block diagram illustrating an exemplary configuration of a network according to an embodiment of the present disclosure;

FIG. 3 is a block diagram illustrating an exemplary configuration of a base station according to the embodiment of the present disclosure;

FIG. 4 is a block diagram illustrating an exemplary configuration of a centralized control server according to the embodiment of the present disclosure;

FIG. 5 is a block diagram illustrating an exemplary configuration of a terminal according to the embodiment of the present disclosure;

FIG. 6 illustrates an exemplary model of reinforcement learning;

FIG. 7 illustrates an exemplary multi-agent model;

FIG. 8 illustrates an exemplary model in which learners are provided for agents, respectively;

FIG. 9 illustrates an exemplary model in which a learner common among agents is provided;

FIG. 10 illustrates an exemplary sequence of processing procedures in an embodiment of the present disclosure;

FIG. 11 illustrates an exemplary model including learners in Variation 1;

FIG. 12 illustrates an exemplary model including learners in Variation 2; and

FIG. 13 illustrates an exemplary model in a case where information exchange is performed in Variation 2.

### DESCRIPTION OF EMBODIMENTS

Hereinafter, a suitable embodiment of the present disclosure will be described in detail with reference to the accompanying drawings. Note that, constituent elements having substantially the same functions are denoted by the same reference signs in the present specification and drawings to thus omit repetitive descriptions thereof.

### Embodiment

In unlicensed bands (for example, frequency bands such as 920 MHz band, 2.4 GHz band, and 5 GHz band), communication is performed by Internet of Things (IoT) terminals and/or Machine to Machine (M2M) terminals in addition to wireless Local Area Network (LAN) communication.

For the IoT or the M2M, for example, studies have been carried out on utilizing a radio communication technique called Low Power Wide Area (LPWA), which enables wide area communication with low power consumption.

The LPWA includes a plurality of schemes (standards or Radio Access Technologies (RATs)). The communication schemes of the LPWA include, for example, the first communication scheme in which spread spectrum techniques are used for communication and the second communication scheme in which the spread spectrum techniques are not used for communication. The first communication scheme includes a communication scheme called “LoRa”, for example. Further, the second communication scheme includes a communication scheme called “Wireless Smart Utility Network (Wi-SUN)”, for example.

A terminal supporting communication in the LPWA system (hereinafter may be referred to as an “LPWA terminal”) is not limited to a terminal owned by a user, but is mounted on various devices. For example, the LPWA terminal is mounted on home appliances such as a television, an air conditioner, a washing machine, and a refrigerator, as well as on mobile transportation systems such as a vehicle.

In addition to the LPWA, various systems including Wi-fi (registered trademark) and Radio Frequency IDentifier (RFID), for example, use the unlicensed bands, which therefore results in a rapid increase in traffic and increased interference.

For this reason, in an LPWA system, for example, it is desirable that a parameter (for example, a channel) to be used for communication by an LPWA terminal be appropriately determined in view of interference or the like.

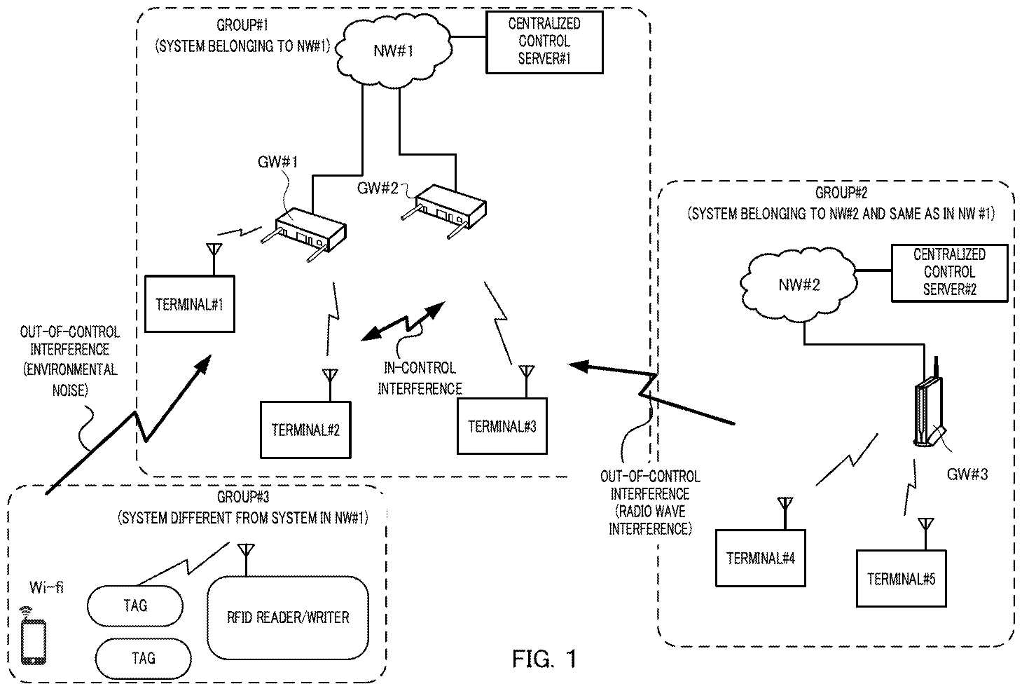

FIG. 1 illustrates an outline of radio systems including the LPWA.

FIG. 1 illustrates group #1, group #2, and group #3. Each group includes a plurality of apparatuses.

Each of groups #1 and #2 is the LPWA system. However, network #1 (NW #1) to which each apparatus in group #1 belongs differs from network #2 (NW #2) to which each apparatus in group #2 belongs. For example, NW #1 and NW #2 are networks of the same LPWA system, which are operated by different operators, respectively. The LPWA system of group #2 is an LPWA system of a network that is not controlled by group #1 (out-of-control network).

Group #1 includes apparatuses that belong to NW #1 and are connected to NW #1 by wire or radio. For example, group #1 includes gateway #1 (GW #1), GW #2, and terminals #1 to #3 in the LPWA system. Further, group #1 includes centralized control server #1 that performs centralized control of the GWs and the like via NW #1.

Group #2 includes apparatuses that belong to NW #2 and are connected to NW #2 by wire or radio. For example, group #2 includes GW #3 and terminals #4 and #5 in the LPWA system. Further, group #2 includes centralized control server #2 that performs centralized control of the GW and the like via NW #2.

Note that, the respective numbers of apparatuses in group #1 and group #2 in FIG. 1 are examples, and the present disclosure is not limited thereto. For example, the number of GWs included in one group may be equal to or greater than three. Further, the number of terminals included in one group may be one or may be equal to or greater than four.

Further, other apparatuses may be connected to the NW of each group. For example, group #1 may include a relay station that relays radio communication between GW #1 and/or GW #2 and terminals #1 to #3. Note that, group #2 may also include a similar relay station.

Group #3 is a radio system different from the radio system (LPWA system) of group #1. The radio system of group #3 is a radio system of an out-of-control network, which is not controlled by group #1. The radio system of group #3 is, for example, RFID, Wi-fi, and the like. Group #3 includes, for example, an RFID reader/writer, an RFID tag, and a terminal that uses Wi-fi. Note that, the radio system of group #3 may include a Long Term Evolution (LTE) system, a radar system, and the like. In addition, group #3 may include noise sources other than the radio systems, such as home appliances, lighting equipment, and heavy machine equipment.

Note that, the network configuration and/or the apparatus configuration illustrated in FIG. 1 are/is exemplary and the present disclosure is not limited thereto.

Note that, the GW described above may have a function of an interference monitoring apparatus that measures interference. The “base station” in the following description corresponds to the GW having the function of an interference monitoring apparatus. The expression “interference monitoring” may be replaced with any other expression such as “radio wave monitoring” and “communication environment monitoring”.

Further, each network illustrated in FIG. 1 may also include other apparatuses different from the apparatuses illustrated in FIG. 1. In this case, the other apparatuses may have one, some or all of the functions of the apparatuses illustrated in FIG. 1. In a case where a relay station is provided in group #1 or group #2, for example, the relay station may have the function of an interference monitoring apparatus. The relay station may also have the GW function and the interference monitoring function. Alternatively, the relay station may have the function of an interference monitoring apparatus and may not have the GW function.

Each radio apparatus in groups #1 to #3 uses a common system band (for example, unlicensed band). Thus, each radio apparatus included in groups #1 to #3 receives interference by other radio apparatuses. Hereinafter, the interference received by the radio apparatuses included in group #1 will be described as an example.

For example, a signal transmitted from the first radio apparatus (for example, terminal #2) included in group #1 to the second radio apparatus (for example, GW #1) included in group #1 may also be received (detected) by the third radio apparatus (for example, GW #2) included in group #1. In this case, interference due to the signal may be caused in the third radio apparatus. Hereinafter, an interference signal received by a radio apparatus belonging to NW #1 from another radio apparatus belonging to NW #1 may be referred to as an “in-control signal”. For example, the in-control signal corresponds to interference received by a radio apparatus, which supports the LPWA system communication and belongs to NW #1, from another radio apparatus which supports the LPWA system communication and belongs to NW #1.

Further, a signal(s) transmitted by a radio apparatus(es) included in group #2 and/or group #3 (for example, terminal #5 and/or the RFID reader/writer), for example, cause(s) interference in a radio apparatus included in group #1 (for example, terminal #1). Hereinafter, interference received by a radio apparatus belonging to NW #1 from a radio apparatus not belonging to NW #1 may be referred to as “out-of-control interference”. For example, the out-of-control interference corresponds to interference received by a radio apparatus, which supports the LPWA system communication and belongs to NW #1, from a radio apparatus which does not belong to NW #1. Alternatively, the out-of-control interference corresponds to an interference component obtained by removing in-control signals from detected signals (interference).

The out-of-control interference may be further classified based on interference factors.

For example, a signal transmitted by a radio apparatus (for example, terminal #4) included in group #2 causes interference in a radio apparatus (for example, GW #1) included in group #1. Hereinafter, interference received by a radio apparatus belonging to NW #1 from a radio apparatus belonging to NW #2 may be referred to as, of the “out-of-control interference”, “radio wave interference”. For example, the “radio wave interference” corresponds to interference received by a radio apparatus, which supports the LPWA system communication and belongs to NW #1, from a radio apparatus which supports the LPWA system communication and belongs to NW #2 different from NW #1.

Further, for example, a signal transmitted by a radio apparatus (for example, the RFID reader/writer) included in group #3 causes interference in a radio apparatus (for example, GW #1) included in group #1. Hereinafter, interference received by a radio apparatus, which supports the LPWA system communication and belongs to NW #1, from a radio apparatus which supports a radio system different from the LPWA system may be referred to as, of the “out-of-control interference”, “environmental noise”.

As illustrated in FIG. 1 with examples, the LPWA system uses a common system band with a radio system different from the LPWA system and/or the same LPWA system that belongs to a different network. In such a situation, a radio communication environment varies depending on a difference(s) in time and/or space, and appropriate radio communication control in accordance with the environment is desirable.

Radio communication control based on a general rule (which may be referred to as “rule-based radio communication control”) is applicable in a limited radio communication environment (for example, the size of a communication area and/or the number of terminals, or the like), but may not be applicable in a case where the range of the limited radio communication environment is exceeded. Alternatively, rule adjustment and/or parameter adjustment may be required for each radio communication environment.

Further, in a case where a rule applicable to a wider range of radio communication environment is designed, the number of parameters and the number of processing steps based on the rule or the like may increase in the designed rule and complexity may be caused.

Further, even in a case where a rule applicable to a wider range of radio communication environment is designed, review and adjustment of the designed rule are to be required with respect to a change in the radio communication environment (for example, an increased number of communication areas due to new base station installation).

As described above, the radio communication control based on a general rule is enormously costly in terms of the design and development of the rule. Further, the case of control based on a designed rule is also costly in terms of the operation thereof.

A non-limiting and exemplary embodiment of the present disclosure describes that control adapted to a radio communication environment (for example, parameter control) is realized by using reinforcement learning, which is an example of machine learning, without performing complicated rule designing and parameter adjustment.

<Exemplary Configuration of Network>

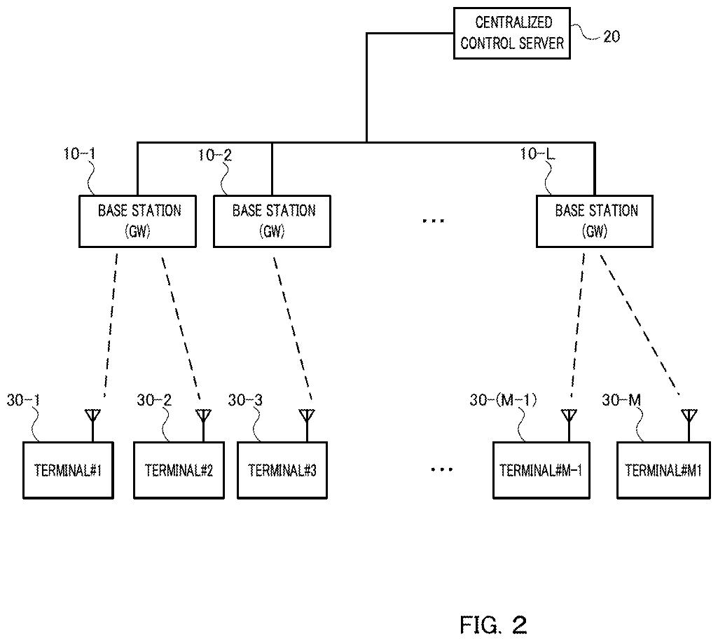

FIG. 2 is a block diagram illustrating an exemplary configuration of a network (NW) according to the present embodiment. The network illustrated in FIG. 2 includes base station 10 (base stations 10-1 to 10-L (where L is an integer equal to or greater than 1)), centralized control server 20, and terminals 30-1 to 30-M (hereinafter may be referred to as terminals #1 to #M (where M is an integer equal to or greater than 1)). The apparatuses included in the network illustrated in FIG. 2 correspond to the apparatuses in group #1 illustrated in FIG. 1, and support the LPWA system communication, for example.

Base station 10 is connected to terminal 30 (one of terminals #1 to #M) by radio, and performs radio communication with the terminal in a channel assigned to the terminal. Base station 10 also performs interference monitoring in each usable channel, and outputs a classification result of interference to centralized control server 20.

Centralized control server 20 is connected to base station 10 by wire, and acquires the classification result from base station 10. Centralized control server 20 may also acquire information on a terminal connected to base station 10 by radio from base station 10. Centralized control server 20 determines a channel to be assigned to the terminal by base station 10 based on the classification result. Centralized control server 20 outputs assignment information, which includes information on the channel to be assigned to the terminal, to base station 10.

Each of terminals #1 to #M is an LPWA terminal that performs the LPWA system communication with base station 10 (one of base stations 10-1 to 10-L).

<Exemplary Configuration of Base Station>

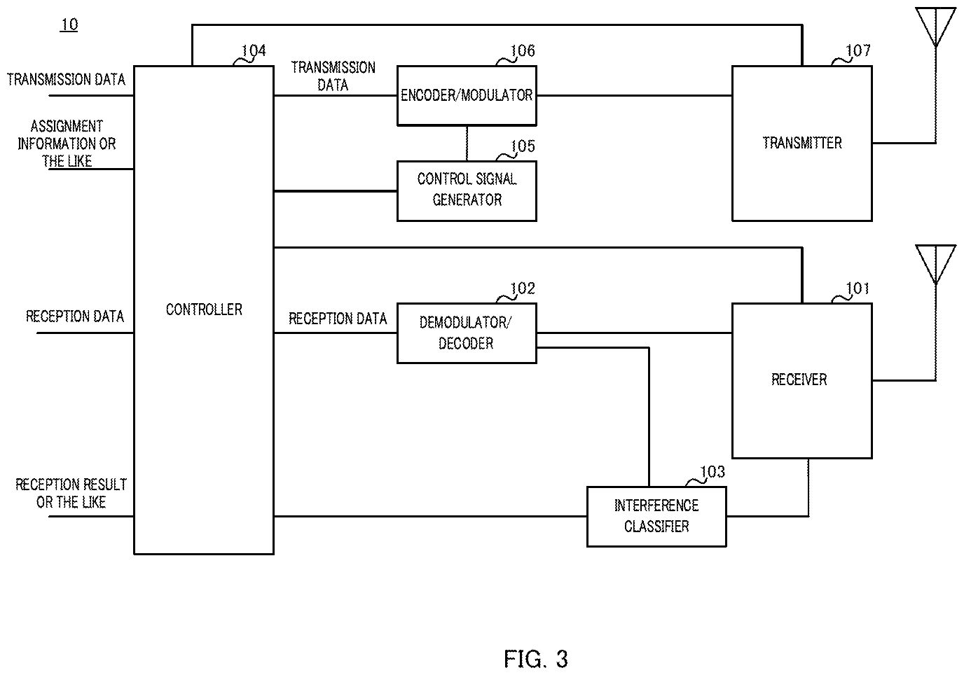

FIG. 3 is a block diagram illustrating an exemplary configuration of base station 10 according to the present embodiment. Base station 10 corresponds to, for example, GW #1 or GW #2 belonging to NW #1 illustrated in FIG. 1.

Base station 10 includes receiver 101, demodulator/decoder 102, interference classifier 103, controller 104, control signal generator 105, encoder/modulator 106, and transmitter 107.

Receiver 101 receives a signal transmitted by a terminal, and performs predetermined reception processing on the received signal. For example, the predetermined reception processing includes frequency conversion processing (down-conversion) based on the frequency of a channel assigned to the terminal or the frequency of a channel for transmitting a control signal. Information on the frequency of the channel assigned to the terminal may be acquired from controller 104, for example.

Receiver 101 also receives (detects) a signal in each usable channel in a system band (for example, each channel included in an unlicensed band) for interference measurement (for example, radio wave monitoring). Then, receiver 101 performs predetermined reception processing on the received signal. The predetermined reception processing includes, for example, frequency conversion processing based on the frequency of each channel. Each usable channel in the system band may correspond to a candidate channel(s) that can be assigned to terminal 30.

Receiver 101 outputs the reception signal subjected to the predetermined reception processing to demodulator/decoder 102 and interference classifier 103.

Demodulator/decoder 102 performs demodulation processing and decoding processing on the reception signal acquired from receiver 101, generates reception data, and outputs the reception data to controller 104. Note that, the reception data may include an identifier for identifying a terminal belonging to the same NW (NW #1) as that of base station 10. Note that, demodulator/decoder 102 may also output information, which indicates success or unsuccess of reception of the reception signal, to controller 104. For example, demodulator/decoder 102 may determine the success of the reception of the reception signal in a case where the reception data has been able to be generated or in a case where there is no error in the reception data.

Interference classifier 103 performs, for example, radio wave monitoring. For example, interference classifier 103 detects interference in each channel and classifies the detected interference. For example, interference classifier 103 monitors reception signals for a predetermined time in one channel, and classifies the in-control signal(s) described above and the out-of-control interference described above from the reception signals.

For example, interference classifier 103 detects the preamble of a reception signal. The preamble of the LPWA system is given to a signal transmitted by a terminal supporting the LPWA system. For example, interference classifier 103 calculates correlation between the preamble used in the LPWA system and a reception signal. The preamble used in the LPWA system may be common regardless of the NWs to which terminals as the transmission sources of reception signals belong.

Interference classifier 103 determines that the transmission source of a reception signal is not an LPWA terminal in a case where the result of the correlation between the preamble and the reception signal does not have a peak equal to or greater than a predetermined value. In this case, interference classifier 103 determines that the transmission source of the reception signal is a radio apparatus supporting a radio system different from the LPWA system, and that the reception signal corresponds to environmental noise which is an example of the out-of-control interference.

For example, interference classifier 103 determines that the transmission source of a reception signal is an LPWA terminal in a case where the result of the correlation between the preamble and the reception signal has a peak equal to or greater than the predetermined value.

Here, the preamble used for the LPWA system communication may be common regardless of the NWs to which the source terminals of reception signals belong. Thus, in a case where interference classifier 103 determines that the transmission source of a reception signal is an LPWA terminal, interference classifier 103 determines whether the NW to which the transmission source belongs is the same NW (NW #1) as that of base station 10 or an NW different from that of base station 10 (for example, NW #2 in FIG. 1).

For example, interference classifier 103 determines, based on the decoding result of the reception signal acquired from demodulator/decoder 102, the NW to which the transmission source belongs. In a case where a reception signal is correctly decoded and the reception signal includes an identifier, for example, interference classifier 103 determines that the NW to which the transmission source of the reception signal belongs is the same NW as that of base station 10. On the other hand, in a case where a reception signal is not correctly decoded and the reception signal includes no identifier, for example, interference classifier 103 determines that the NW to which the transmission source of the reception signal belongs is an NW different from that of base station 10.

In a case where the transmission source of a reception signal is an LPWA terminal belonging to NW #1 which is the same as that of base station 10, interference classifier 103 determines that the reception signal corresponds to the in-control signal. In a case where the transmission source of a reception signal is an LPWA terminal belonging to an NW different from that of base station 10, interference classifier 103 determines that the reception signal corresponds to the radio wave interference which is an example of the out-of-control interference.

Note that, the classification method in interference classifier 103 is not limited to the above-described method based on the preamble detection result of the reception signal and the decoding result of the reception signal.

For example, interference classifier 103 may classify reception signals into the in-control signal and the interference different from the in-control signal (out-of-control interference). In this case, interference classifier 103 may not classify the out-of-control interference into the radio wave interference and the environmental noise. For example, interference classifier 103 may detect the out-of-control interference by classifying in-control signals from reception signals and subtracting the in-control signals from the reception signals, based on the decoding results of the reception signals. Further, interference classifier 103 may also determine the amount of interference of a reception signal without reception signal classification into the in-control signal and the out-of-control interference.

Interference classifier 103 determines the channel occupancy (channel utilization) and reception level in each channel from the amount of interference.

Interference classifier 103 performs the radio wave monitoring and outputs information indicating the result of the radio wave monitoring to controller 104. The information to be outputted to controller 104 may include, for example, the aforementioned channel occupancy (channel utilization) and reception level in each channel, or the like.

Note that, the expression of the amount of interference is not particularly limited. For example, the amount of interference may be expressed in terms of the average value, minimum value, or maximum value of reception signal power (which may also be referred to as interference power). Alternatively, the amount of interference may be expressed using a relationship between reception signal power and a time duration (which may be referred to as a monitoring duration) in which a reception signal is received. For example, the amount of interference may be expressed in terms of, for example, a time duration in which reception signal power has a value equal to or greater than a predetermined value, or the like, or may be expressed in terms of whether a time duration in which reception signal power has a value equal to or greater than a predetermined value is equal to or longer than a predetermined length, or the like.

Controller 104 generates data to be outputted to centralized control server 20. For example, controller 104 outputs information (for example, a reception result or the like) to centralized control server 20, where the information indicates at least one of success or unsuccess of reception of a reception signal by base station 10, a successful reception rate, and/or a time interval of successful reception. For example, controller 104 may calculate the successful reception rate and/or the time interval of successful reception based on information indicating success or unsuccess of reception of a reception signal at each of a plurality of reception timings.

Further, controller 104 outputs information such as the channel occupancy (channel utilization) and reception level in each channel to centralized control server 20 in NW #1 (see FIGS. 1 and 2). The information to be outputted from controller 104 to centralized control server 20 may be referred to as a reception result indicating a result of reception processing in base station 10. Note that, the reception processing in base station 10 may include processing on a signal transmitted from terminal 30 to base station 10 and processing on a signal obtained by monitoring each candidate channel.

Note that, controller 104 may perform conversion processing on the information for being outputted to centralized control server 20 and output the information subjected to the conversion processing to centralized control server 20.

Controller 104 acquires, from centralized control server 20 in NW #1 (see FIGS. 1 and 2), information on a parameter configured for terminal 30.

Controller 104 outputs the information on the parameter to control signal generator 105.

Controller 104 also controls data communication with a terminal. For example, controller 104 may output the reception data acquired from demodulator/decoder 102 to an external network (not illustrated) or another apparatus in NW #1. Further, controller 104 outputs transmission data addressed to terminal 30, which has been acquired from the external network or the other apparatus in NW #1, to encoder/modulator 106.

Control signal generator 105 generates a control signal including control information addressed to the terminal based on the information acquired from controller 104. Control signal generator 105 outputs the control signal to encoder/modulator 106.

Encoder/modulator 106 performs encoding processing and modulation processing on the transmission data acquired from controller 104 and generates a transmission signal. Encoder/modulator 106 also performs encoding processing and modulation processing on the control signal acquired from control signal generator 105 and generates a transmission control signal. Encoder/modulator 106 outputs the transmission signal and/or the transmission control signal to transmitter 107.

Transmitter 107 performs predetermined transmission processing on the transmission signal. For example, the predetermined transmission processing includes frequency conversion processing (up-conversion) based on the frequency of a channel assigned to terminal 30. Information on the frequency of the channel assigned to terminal 30 may be acquired from controller 104, for example.

Further, transmitter 107 performs predetermined transmission processing on the transmission control signal. For example, the predetermined transmission processing includes frequency conversion processing (up-conversion) based on the frequency of a channel for transmitting the transmission control signal to terminal 30. The channel for transmitting the transmission control signal to terminal 30 may be, for example, a predetermined channel or a channel currently used for communication with terminal 30.

<Exemplary Configuration of Centralized Control Server>

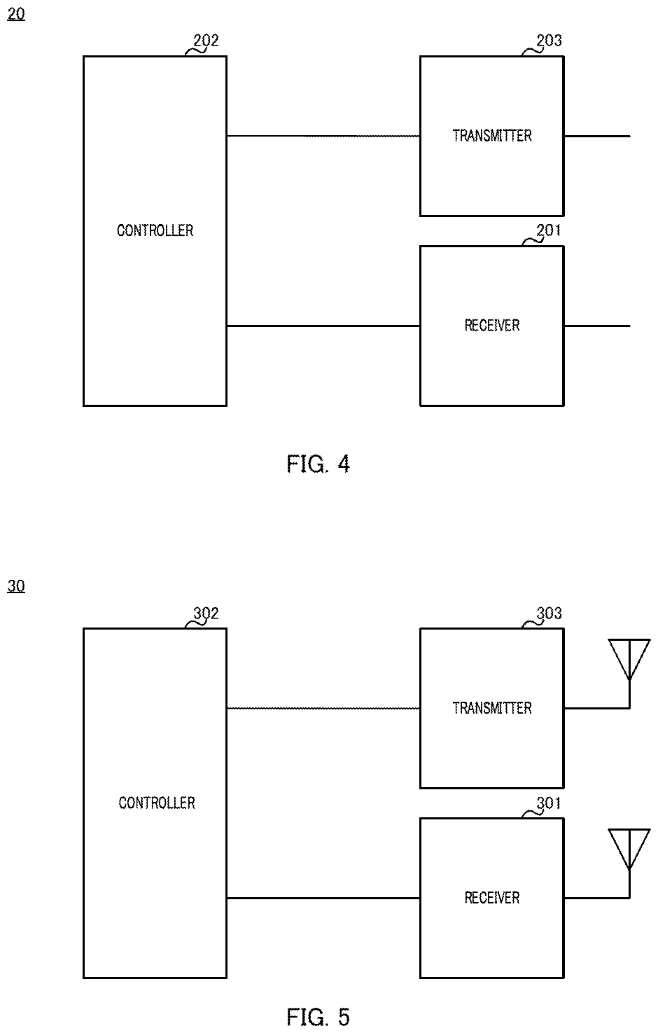

FIG. 4 is a block diagram illustrating an exemplary configuration of centralized control server 20 according to the present embodiment. Centralized control server 20 belongs to, for example, NW #1 illustrated in FIG. 1. For example, centralized control server 20 is connected to above-described base station 10 by wire. Alternatively, centralized control server 20 may be connected to a network, such as the Internet, by wire, and may be connected to base station 10 via the network.

Centralized control server 20 includes receiver 201, controller 202, and transmitter 203.

Receiver 201 receives, for example, information from base station 10. For example, the information received from base station 10 includes a reception result indicating a result of a reception processing in base station 10. The reception result includes information indicating at least one of success or unsuccess of reception, a successful reception rate, and/or a time interval of successful reception. The reception result may also include at least one of the channel utilization in each channel and/or the reception level in each channel.

Controller 202 selects (determines) a parameter to be configured for each terminal 30 based on the information received from base station 10. For example, controller 202 performs learning processing based on the reception result and selects (determines) a channel to be assigned to terminal 30.

Note that, the learning processing in controller 202 may be executed by, for example, a learner (not illustrated) included in controller 202.

Transmitter 203 transmits information including the parameter for terminal 30, which has been configured by controller 202, to base station 10.

Note that, although an example in which the configurations illustrated in FIG. 3 are included in one base station 10 and the configurations illustrated in FIG. 4 are included in one centralized control server 20 has been described above, the present disclosure is not limited thereto. For example, base station 10 may include at least one or some of the configurations in centralized control server 20 illustrated in FIG. 4, and centralized control server 20 may include at least one or some of the configurations in base station 10 illustrated in FIG. 3. In the network illustrated in FIG. 2, for example, at least one base station 10 may include the configurations in centralized control server 20 illustrated in FIG. 4.

For example, the configurations in base station 10 illustrated in FIG. 3 may be divided between the first apparatus having a communication function of the LPWA system and the second apparatus having a function of a radio wave interference monitoring apparatus (for example, interference classifier 103).

<Exemplary Configuration of Terminal>

FIG. 5 is a block diagram illustrating an exemplary configuration of terminal 30 according to the present embodiment. Terminal 30 includes receiver 301, controller 302, and transmitter 303.

Receiver 301 receives a signal from base station 10, for example, via an antenna. For example, the signal received from base station 10 is a signal including downlink data and/or a signal including control information. Receiver 301 performs reception processing on the received signal and outputs the downlink data and/or the control information to controller 302.

Controller 302 processes the downlink data and outputs the processed downlink data to a processor of a higher layer (not illustrated). Controller 302 outputs uplink data acquired from the processor of the higher layer to transmitter 303.

Controller 302 configures a radio communication-related parameter based on downlink control information. For example, controller 302 configures a channel to be used for signal transmission processing based on channel information included in the control information. Further, controller 302 configures other parameters (for example, spreading factor and transmission power) included in the control information as parameters to be used for the signal transmission processing. Controller 302 also generates uplink control information and outputs the generated uplink control information to transmitter 303.

Transmitter 303 performs transmission processing of the uplink data and/or the control information and generates a transmission signal. Transmitter 303 transmits the transmission signal via an antenna.

Note that, controller 302 may configure the parameters to be used for signal reception processing based on the control information.

<Reinforcement Learning>

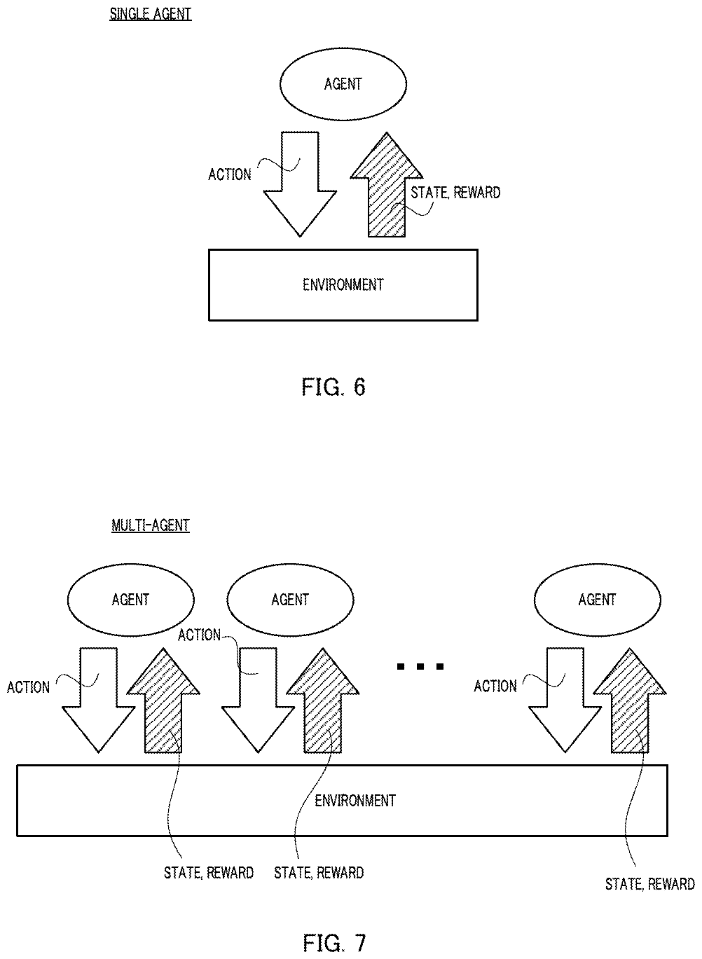

Next, reinforcement learning will be described as exemplary machine learning to be executed by controller 202 of centralized control server 20. FIG. 6 illustrates an exemplary model of the reinforcement learning.

The reinforcement learning is a framework in which an “agent” as the subject of an “action” performs trial and error based on “experience” and acquires a more suitable “action”. Here, the “experience” corresponds to, for example, a “state” and/or “reward” obtained by observation. For example, a Markov decision process is used as an exemplary mathematical model for describing interaction between the “agent” and the “environment”. In the learning model illustrated in FIG. 6, the Markov decision process is used for one “agent” (single agent).

For example, in the Markov decision process, a transition probability of state transition at a certain point in time is defined by a “state” prior to the point in time and an “action” at the point in time.

Modeling the action, state, reward, and the like and determining an appropriate criterion (also referred to as “policy”, for example) for action decision make it possible to apply the reinforcement learning to an object to controlled.

In the present embodiment, reinforcement learning models to be applied to an LPWA network that operates in a frequency band in which a plurality of radio systems coexist, as described above, will be described.

For example, in the present embodiment, the “agent” corresponds to a “terminal” (for example, an LPWA terminal). Accordingly, in the present embodiment, a plurality of agents may be present in an environment, that is, a multi-agent environment. Further, the “agent” and the “terminal” may be interchangeably used in the following description.

FIG. 7 illustrates an exemplary multi-agent model. In the present embodiment, a multi-agent example as illustrated in FIG. 7 will be described.

Then, the “action” for each agent corresponds to, for example, channel selection from candidate channels (channel assignment). For example, in a case where the channel selection is executed by the base station, the “action” for each agent corresponds to communication using the selected channel.

The “state” for each agent corresponds to, for example, the channel occupancy (utilization) in each candidate channel and/or the reception level at the base station.

The “reward” for each agent corresponds to, for example, a reception result in the base station. For example, the reception result may be the successful reception rate and/or the interval among a plurality of times of successful receptions (successful reception interval), or the like.

Then, the “learning” corresponds to, for example, updating of the criterion (policy) for action decision in accordance with the “state” and/or “reward” described above.

Here, in the reinforcement learning, the more the number of times of “actions” and the more the opportunities for “learning” associated therewith, the more appropriate “criterion (policy)” is reached.

In the LPWA network, the number of terminals is numerous in comparison with that in a wireless LAN or the like and the number of the communication occasion in a predetermined time in each terminal is, on the other hand, relatively low (in other words, the number of times of “actions” is relatively small). Accordingly, in a case where terminals perform learning individually, the learning opportunities decrease, the learning does not progress, and it is difficult to reach a more appropriate “criterion (policy)”.

Accordingly, in the present embodiment, a common learner is provided among terminals that are agents.

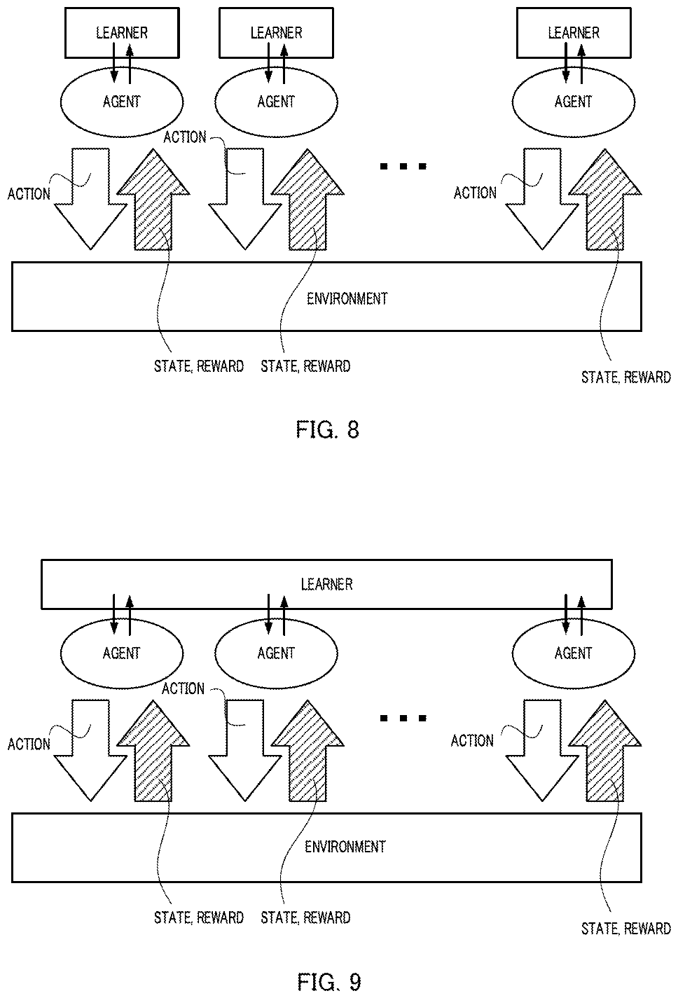

FIG. 8 illustrates an exemplary model in which learners are provided for agents, respectively. FIG. 9 illustrates an exemplary model in which a learner common among agents is provided.

In comparison with FIG. 8, in FIG. 9, the action of each agent and the state and/or reward with respect to the action are used in the learner common among the agents. Accordingly, it is possible to advance learning quickly and to cause a more appropriate “criterion (policy)” to be easily reached. Since the LPWA network includes a large number of terminals, the progress of learning can be improved.

Note that, although the example described above has indicated that the “action” for each agent is the channel selection, the present disclosure is not limited thereto. For example, the “action” for each agent may be any other parameter (for example, spreading factor, transmission power, or Modulation and Coding Scheme (MCS)) to be configured with respect to communication, or the like. Alternatively, the “action” for each agent may be a combination of two or more of communication-related parameter configurations including the channel selection.

Further, in the example described above, the modeling may be common for each agent or the modeling may vary for each agent. For example, the “action” of agent #1 may be the channel selection and the “action” of agent #2 may be spreading factor configuration. In this case, as the learning progresses, the channel to be selected by agent #1 becomes a more suitable channel, and the spreading factor to be configured by agent #2 becomes a more suitable spreading factor.

<Processing Procedures>

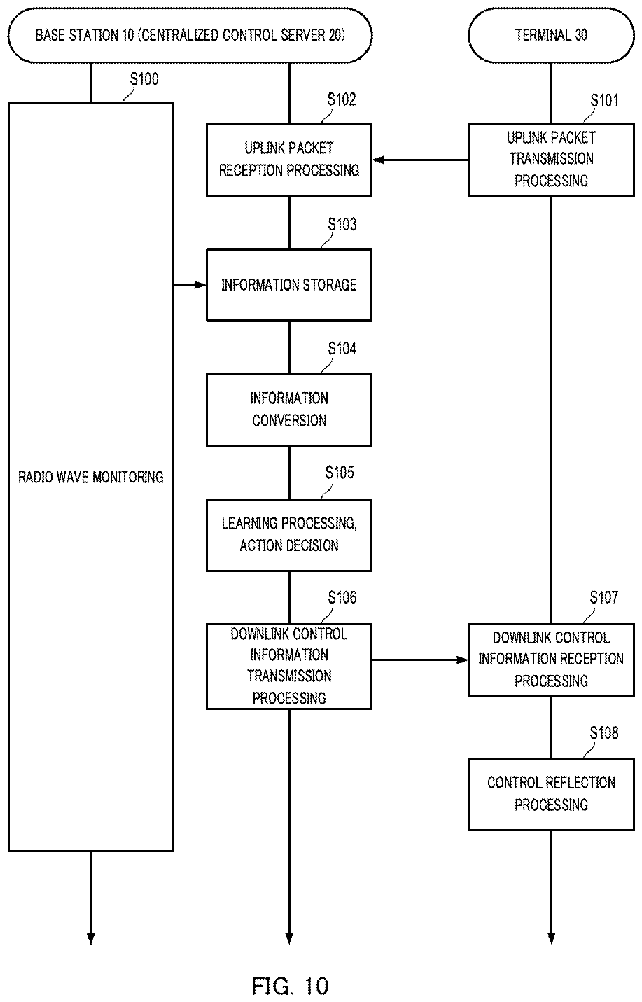

Exemplary processing procedures of terminal 30 as well as base station 10 and centralized control server 20 in the present embodiment will be described. FIG. 10 illustrates an exemplary sequence of processing procedures in the present embodiment. Note that, FIG. 10 illustrates an example in which base station 10 includes the configurations in centralized control server 20 described above.

Base station 10 performs radio wave monitoring (S100). For example, base station 10 monitors the channel utilization in each candidate channel and measures the channel utilization. The radio wave monitoring may be executed constantly or periodically.

The channel utilization in a certain channel may be defined by the ratio of the time when the channel is in use within a certain unit time to the unit time. For example, in a case where reception power equal to or greater than a threshold value is measured in a certain channel, it may be determined that the channel is in use, whereas in a case where reception power less than the threshold value is measured in a certain channel, it may be determined that the channel is not in use.

Alternatively, the channel utilization may not be a local value, but may be a value obtained by averaging values of channel utilizations in a plurality of unit times. Alternatively, a value(s) extremely deviating from an average of values of channel utilizations in a plurality of unit times may be excluded and the plurality of channel utilizations after the exclusion may be averaged. Such data processing (statistical processing) that improves probability of a measured value may be performed on the channel utilization.

Terminal 30 performs transmission processing of a packet to be transmitted uplink (uplink packet) (S101). Base station 10 performs reception processing of the uplink packet (S102).

Then, base station 10 determines a reception result of each candidate channel. For example, base station 10 determines whether base station 10 has been able to receive the uplink packet from terminal 30.

Then, information on the reception result indicating whether base station 10 has been able to receive the uplink packet (reception OK) or has not been able to receive the uplink packet (reception NG) is stored (S103). Further, the information on the reception result to be stored may include the channel utilization and the reception power (for example, received signal strength indicator (RSSI)). Note that, the information to be stored may be at least one of the reception result, the channel utilization, and/or the reception power. Alternatively, the information to be stored may be other than those described above.

Here, when it cannot be determined that base station 10 has not been able to receive the uplink packet (reception NG), there may be, for example, a case where the reception power is small and it cannot be determined that the packet has been transmitted from terminal 30. For example, in a case where an application for periodically receiving a packet from terminal 30 is in operation, the reception NG may be determined at periodic timings. Further, in the case of the reception NG, the reception power may be extremely small. In a case where the reception power is too small to be measured, a specified value may be stored instead of a measured value of the reception power. For example, the specified value in this case may be a value less than the minimum value in a measurable range of the reception power.

Next, base station 10 performs conversion processing on the stored information (S104). In the conversion processing here, for example, the stored information is converted into data to be handled in the learning processing of the learner described above. For example, the reception power (for example, RSSI) is converted into a value in a range from “0” to “1”. Further, for example, in a case where the reception result indicates the reception OK, the reception result is converted into “+1”, whereas in a case where the reception result indicates the reception NG, the reception result is converted into “−1”. Further, a reception result for a plurality of packets may be converted into the successful reception rate and/or the time interval of successful reception.

Base station 10 outputs the information subjected to the conversion processing to the learner.

The learner performs the learning processing and determines, from candidate channels, a channel to be assigned to terminal 30 (an exemplary action) (S105). A learning algorithm to be used in the learning processing is not particularly limited. The learning algorithm to be used in the learning processing may be a general algorithm for reinforcement learning. Illustrative examples of the algorithm for reinforcement learning include Q-learning, SARSA, Actor-Critic, policy gradient method, Deep Q-Network (DQN), Proximal Policy Optimization (PPO), REINFORCE, and the like. In the present embodiment, one of these algorithms for reinforcement learning may be used, an algorithms other than these algorithms may be used, or a plurality of algorithms for reinforcement learning may be combined.

Base station 10 performs transmission processing to transmit downlink control information including information on the determined channel to terminal 30 (S106). For example, base station 10 transmits a downlink control signal including the downlink control information to terminal 30.

Note that, in the LPWA network, the reception timing in terminal 30 may be limited. For example, in LoRa-WAN Class A, the downlink reception time and the uplink transmission time in terminal 30 are provided near each other on the time axis in order to suppress the battery driving time in terminal 30. For example, the downlink reception timing in terminal 30 is limited to a predetermined time after uplink transmission by terminal 30. The battery driving time in terminal 30 is extended from the downlink reception start timing to the uplink transmission end timing.

Note that, in a case where the packet cannot be received in the reception processing in S102 (in the case of the reception NG), the downlink control information may not be transmitted. However, in a case where the packet reception timing is known, for example, in a case where an application for receiving the packets from terminal 30 at a known timing is in operation, the downlink control information may be transmitted despite the reception NG.

Terminal 30 performs reception processing of the downlink control information including the channel information (S107).

Terminal 30 performs processing of causing control of terminal 30 to reflect the information included in the downlink control information (control reflection processing) (S108). For example, terminal 30 configures the channel indicated by the channel information as the channel for transmitting the uplink packet.

Terminal 30 uses the configured channel to transmit the uplink packet in, for example, the next uplink transmission time.

Note that, although omitted in FIG. 10, base station 10 may perform reception processing on uplink packets (exemplary transmission signals) transmitted from a plurality of terminals 30 and store information on the respective reception results of the plurality of terminals 30. In this case, base station 10 converts the information on the respective reception results of the plurality of terminals 30 and transmits the converted information to a common learner.

Further, although an example in which base station 10 includes the configurations in centralized control server 20 described above has been indicated in FIG. 10, base station 10 may be configured differently from centralized control server 20. In this case, part of the processing illustrated in FIG. 10 may be executed by base station 10 and part of the remaining processing may be executed by centralized control server 20.

For example, in S103, base station 10 may output the information on the reception result to centralized control server 20 instead of storing the information on the reception result. Further, in this case, S104 and S105 may be executed by centralized control server 20 and centralized control server 20 may output the information on the determined channel to base station 10.

As described above, in the present embodiment, centralized control server 20 (an example of the control apparatus) includes a learner common to a plurality of terminals 30, the learner performs machine learning based on reception results of signals transmitted from the plurality of terminals 30, respectively, and determines channels (an example of the radio communication-related parameter) to be assigned to the plurality of terminals 30, respectively. This makes it possible to easily control the radio communication-related parameter in accordance with a change in a radio communication environment without performing complicated rule designing and parameter adjustment.

Note that, although the example of the learning model described above has indicated that a learner common to each terminal 30 is provided, the present disclosure is not limited thereto. Hereinafter, variations of the learning model will be described.

<Variation 1>

In Variation 1, learners are provided for Radio Access Technologies (RATs), respectively.

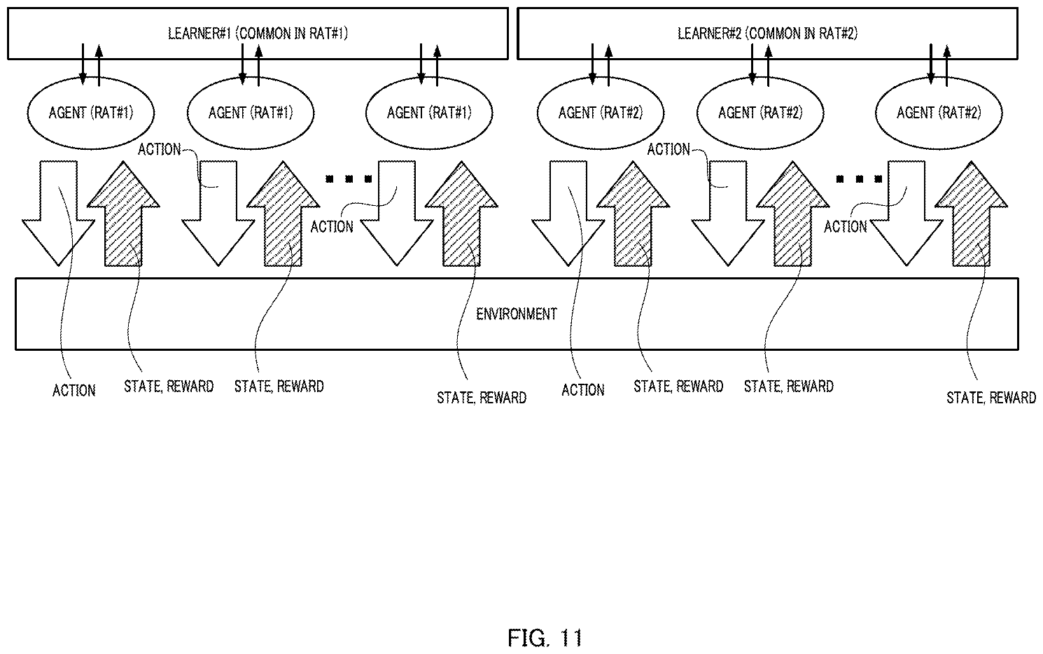

FIG. 11 illustrates an exemplary model including learners in Variation 1. As illustrated in FIG. 11, in Variation 1, a learner common among terminals (among agents) in the same RAT is provided. In this case, the learning results become common within the same RAT. Further, in this case, the learners of the different RATs differ from each other.

For example, the LoRa scheme and the Wi-SUN scheme are RATs different from each other. Such RATs different from each other may have a difference therebetween in communication performance. In a case where a difference in communication performance occurs, the relationship (for example, interference tolerance characteristic, reception power characteristic, SINR characteristic) between the “state” (for example, channel utilization and/or reception power) and the “reward” (for example, reception result) used for the learning varies for each RAT. For example, the LoRa scheme uses spread spectrum techniques and is therefore strongly resistant to interference in comparison with the Wi-SUN scheme. Accordingly, for example, even in a case where the reception power is the same between the LoRa scheme and the Wi-SUN scheme (that is, even in a case where the “state” is the same), the LoRa scheme has a better reception result than the Wi-SUN scheme (that is, a difference occurs in the “reward”).

Further, RATs different from each other may have different occupied bandwidths and the numbers of candidate channels and/or the channel width may vary therebetween. For example, a unit channel of 920 MHz band has a width of 200 kHz, signal transmission in the LoRa scheme is often performed in the occupied bandwidth of 125 kHz, whereas signal transmission in the Wi-SUN scheme is often performed in the occupied bandwidth of 400 kHz. In this case, in the LoRa scheme, the assignment is performed in one channel unit, whereas in the Wi-SUN scheme, the assignment is performed in two channel units. In this case, the one channel unit varies in terms of, for example, the channel utilization corresponding to the “state” and the channel selection corresponding to the “action”.

In view of the situations described above, providing learners for RATs, respectively, makes it possible to define information corresponding to the “state”, information corresponding to the “reward”, and information corresponding to the “action” for each RAT, and to obtain a more suitable learning result for each RAT.

Note that, the respective learners for RATs described above may be included in centralized control servers 20 different from each other or may be included in one centralized control server 20.

Further, some of a plurality of RATs may have a common learner. For example, learner #1 common to RAT #1 and RAT #2 among three RATs (RAT #1, RAT #2, and RAT #3) may be provided, and learner #2 different from learner #1 may be provided for RAT #3.

Further, the present disclosure is not limited to the case where learners are provided for RATs, respectively, but learners may be provided for configurations, respectively.

For example, learners may be provided for spreading factor (SF) configurations, respectively. Thus, even in a case where a difference in communication performance based on a difference between spreading gains occurs, a more suitable learning result can be obtained.

Further, for example, learners may be provided for bandwidth configurations, respectively. Since the number of candidate channels varies depending on the bandwidth configuration, providing learners for bandwidth configuration, respectively, makes it possible to obtain a more suitable learning result.

Further, the present disclosure is not limited to the case where learners are provided for RATs, respectively, but learners may be provided for applications, respectively.

For example, in a case where the configuration varies for each application, learners are provided for the applications, respectively, because a difference in communication performance occurs among the applications or candidate channels change for each application. Further, for example, in a case where the required quality varies for each application, learners may be provided for the applications, respectively, because the performance index changes for each application. Further, for example, learners may be provided for an application to be applied to a terminal that moves and an application to be applied to a terminal that does not move, respectively. Further, learners may be provided for applications, respectively, whose communication frequencies differ from each other.

<Processing Procedures in Variation 1>

Next, processing procedures in Variation 1 will be described with reference to the FIG. 10 described above. Illustratively, terminal #1 is a terminal of RAT #1, terminal #2 is a terminal of RAT #2, base station #0 corresponds to each of RAT #1 and RAT #2, and base station #0 includes learner #1 of RAT #1 and learner #2 of RAT #2.

In the same manner as in the example illustrated in FIG. 10, base station 10 performs the conversion processing on the information (see S104 of FIG. 10) and outputs the information subjected to the conversion processing to the learner. Here, information on a reception result of a packet transmitted from terminal #1 is outputted to learner #1 and information on a reception result of a packet transmitted from terminal #2 is outputted to learner #2. Then, learner #1 performs learning processing based on the acquired information and determines a channel to be assigned to terminal #1 from candidate channels. Learner #2 performs learning processing based on the acquired information and determines a channel to be assigned to terminal #2 from candidate channels. Note that, the candidate channels for learner #1 and the candidate channels for learner #2 may be partially or totally common.

Note that, although two RATs and two learners have been described as an example in the processing procedures described above, the present disclosure is not limited thereto. For example, the number of RATs may be one or may be equal to or greater than three.

Further, even in the same RAT, learners may be provided in accordance with parameter configurations. For example, learners may be provided for spreading factors of the LoRa scheme.

Further, even in the same RAT, learners may be provided in accordance with applications. For example, even in the same the LoRa scheme, different learners may be provided for a monitoring application for a parent to monitor his/her child, who owns a terminal, through position information or the like of the terminal and an environment sensing application for which a large number of environment sensing applications are provided in a factory, a farm, or that like for sensing the environment such as temperature, humidity and the like.

<Variation 2>

In Variation 2, an example in which learners are provided for base stations 10, respectively, will be described.

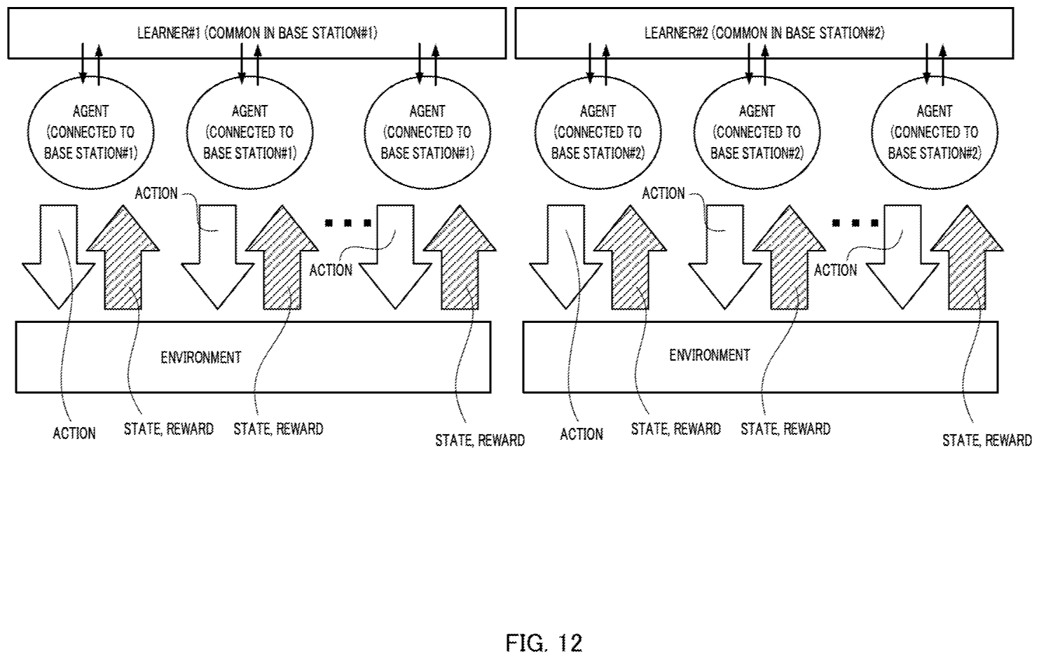

FIG. 12 illustrates an exemplary model including learners in Variation 2. As illustrated in FIG. 12, one learner is provided in association with one base station 10 in Variation 2. In other words, a learner common among terminals connected to the same base station 10 is provided. In this case, the learning results become common within the same base station. Further, in this case, the learners of the different base stations differ from each other.

For example, the respective communication environments (for example, reception states) of a plurality of base stations may vary depending on the locations at which the plurality of base stations is installed, or the like. For example, since a base station provided at a location at which there are relatively few obstacles to radio wave propagation and a base station provided at a location at which there are relatively many obstacles have reception states different from each other, the resulting “states” (for example, reception levels) may differ.

In view of the situations described above, providing learners for base stations, respectively, makes it possible to define information corresponding to the “state”, information corresponding to the “reward”, and information corresponding to the “action” for each base station, and to obtain a more suitable learning result for each base station.

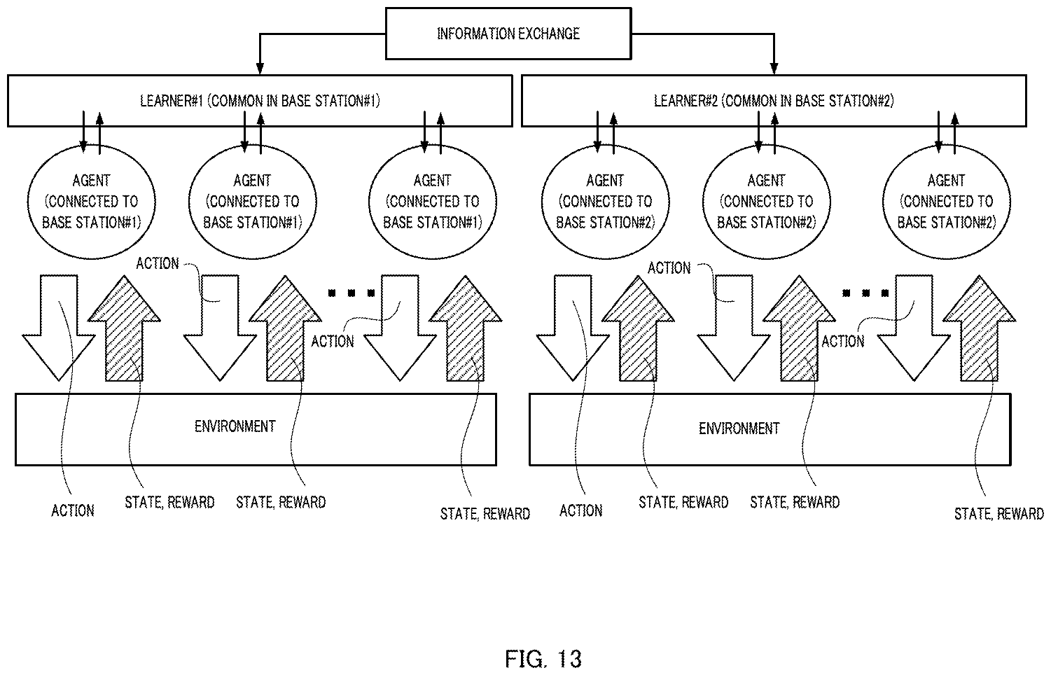

Note that, learners may be provided for base stations, respectively, and information may be exchanged among the learners. FIG. 13 illustrates an exemplary model in a case where information exchange is performed in Variation 2. FIG. 13 is the same as FIG. 12 except that learner #1 and learner #2 perform information exchange.

As illustrated in FIG. 13, each learner advances learning processing independently, exchanges information therebetween, and shares some information. In other words, in the machine learning processing in learner #1, the result (or process) of the machine learning processing in learner #2 is used. This may makes it possible to obtain a more suitable learning result. Here, the information to be shared is not particularly limited.

<Processing Procedures in Variation 2>

Next, processing procedures in Variation 2 will be described with reference to the FIG. 10 described above. Illustratively, base station #1 includes learner #1, base station #2 includes learner #2, terminal #1 is connected to base station #1, and terminal #2 is connected to base station #2. Further, in this example, base station #1, base station #2, terminal #1, and terminal #2 may be of the same RAT.

In the same manner as in the example illustrated in FIG. 10, base station 10 performs the conversion processing on the information (see S104 of FIG. 10) and outputs the information subjected to the conversion processing to the learner. Here, base station #1 outputs information on a reception result of a packet, which is transmitted from terminal #1, to learner #1. Base station #2 outputs information on a reception result of a packet, which is transmitted from terminal #2, to learner #2. Then, learner #1 performs learning processing based on the acquired information and determines a channel to be assigned to terminal #1 from candidate channels. Learner #2 performs learning processing based on the acquired information and determines a channel to be assigned to terminal #2 from candidate channels. Note that, the candidate channels for learner #1 and the candidate channels for learner #2 may be partially or totally common.

Here, learner #1 and learner #2 may exchange information. The information to be exchanged may be, for example, a Q value (for example, action value function) in Q learning in a case where the Q learning is applied to the learning algorithm.

Note that, although two base stations and two learners have been described as an example in the processing procedures described above, the present disclosure is not limited thereto. For example, the number of base stations may be one or may be equal to or greater than three.

For example, base station #1 and base station #3 among base station #1 to base station #3 may include learner #1 common thereto, and base station #2 may include learner #2. For example, in a case where base station #1 and base station #3 are base stations adjacent to each other, a common learner may be used therebetween.

<Variation 3>

In Variation 3, for example, an example in which terminal 30 cannot receive the downlink control information in S107 of FIG. 10 described above will be described. In this example, terminal 30 may autonomously select a channel to be used for communication. For example, terminal 30 may randomly select a channel from candidate channels. Alternatively, terminal 30 may include a history of channels used in communication, and may select a channel based on the history. For example, terminal 30 may select a channel that has been used immediately prior to a channel currently in use and configure the selected channel as the channel to be used at the next point in time. Alternatively, terminal 30 may calculate each average selectivity (average utilization) of candidate channels and select a channel based on the calculated each average selectivity.

<Variation 4>

In Variation 4, an example in which centralized control server 20 selects a plurality of channels to be used for communication by certain terminal 30 in descending order of priority, and transmits downlink control information including channel information on the selected plurality of channels to terminal 30 will be described. In this example, the downlink control information includes the channel information on the plurality of channels. Accordingly, in a case when terminal 30 cannot receive the downlink control information at a certain reception timing, terminal 30 may select a channel to be used for communication by using the downlink control information received prior to the reception timing.

For example, the downlink control information may include the channel information on each of the plurality of channels. For example, the downlink control information may include the channel information on K channels ranging from the first candidate channel to the K candidate channel in descending order of priority. Alternatively, the downlink control information may include information (for example, selection probability) indicating the respective priorities of the plurality of channels.

In a case where terminal 30 can receive the downlink control information, terminal 30 may configure a channel to be used for communication (for example, uplink communication) based on the received downlink control information.

Further, in a case where terminal 30 cannot receive the downlink control information, terminal 30 may configure a channel to be used for communication based on the downlink control information that terminal 30 had received prior to the time when terminal 30 has not been able to receive the downlink control information.

For example, terminal 30 may configure, as a channel to be used for the next communication, a channel having a lower priority than a channel used for communication prior to the time when terminal 30 has not been able to receive the downlink control information. Alternatively, the terminal may perform a reselection based on the selection probability.

Note that, the expression “ . . . er (or)” in the embodiment described above may be replaced with any other expression such as “ . . . circuitry”, “ . . . device”, “ . . . unit” or “ . . . module”.

In addition, the expression “channel” in the embodiment described above may be replaced with any other expression such as “frequency”, “frequency channel”, “band”, “carrier”, “sub-carrier”, or “(frequency) resource”.

Further, the term “calculate” in the embodiment described above may be replaced with any other term such as “determine”, “estimate”, or “derive”.

Furthermore, the term “classify” in the embodiment described above may be replaced with any other term such as “separate” or “extract”.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter or measurement device, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

While various embodiments have been described with reference to the drawings hereinabove, obviously, the present disclosure is not limited to these examples. Obviously, a person skilled in the art would arrive at variations and modification examples within a scope described in claims, and it is understood that these variations and modifications are within the technical scope of the present disclosure. Further, each constituent element of the above-mentioned embodiments may be combined optionally without departing from the spirit of the disclosure.

Specific examples of the present disclosure have been described thus far, but these examples are only exemplary, and are not to limit the claims. Techniques recited in the claims include, for example, variations and/or modifications of the specific examples exemplified above.

The disclosure of Japanese Patent Application No. 2020-132990, filed on Aug. 5, 2020, including the specification, drawings and abstract, is incorporated herein by reference in its entirety.

### INDUSTRIAL APPLICABILITY

The present disclosure is useful for radio communication systems.

### REFERENCE SIGNS LIST

10 Base station
101, 201, 301 Receiver
102 Demodulator/decoder
103 Interference classifier
104, 202, 302 Controller
105 Control signal generator
106 Encoder/Modulator
107, 203, 303 Transmitter
20 Centralized control server
30 Terminal

1. A control apparatus, comprising:
an acquirer that acquires a reception result for each of a plurality of terminals, the reception result indicating a result of reception processing on a signal transmitted from a corresponding one of the plurality of terminals; and
a controller that performs centralized control of the plurality of terminals, wherein the controller performs machine learning common to the plurality of terminals based on at least one of a plurality of the reception results and determines a radio communication-related parameter used by each of the plurality of terminals.

2. The control apparatus according to claim 1, wherein a plurality of the radio communication-related parameters includes at least one kind of a channel, transmission power, and/or a spreading factor that are used by each of the plurality of terminals.

3. The control apparatus according to claim 1, wherein the reception result indicates at least one of success or unsuccess of reception of the signal, a successful reception rate of the signal, and/or a time interval of successful reception of the signal.

4. A control apparatus, comprising:
an acquirer that acquires a reception result for each of a plurality of terminals including a first terminal and a second terminal, the reception result indicating a result of reception processing on a signal transmitted from a corresponding one of the plurality of terminals, the first terminal and the second terminal being terminals in which at least one of a radio communication scheme, a base station, radio communication-related configuration information, and/or an operating application varies between the first terminal and the second terminal, the base station being a base station to which the first terminal and/or the second terminal connect(s) by radio; and
a controller that performs centralized control of the plurality of terminals, wherein:
the controller performs first machine learning common to the first terminal based on a first reception result indicating the result of the reception processing on the signal transmitted from the first terminal and determines the parameter used by the first terminal, and
the controller performs second machine learning common to the second terminal based on a second reception result indicating the result of the reception processing on the signal transmitted from the second terminal and determines the parameter used by the second terminal.

5. The control apparatus according to claim 4, wherein the controller uses, in the first machine learning, information obtained in the second machine learning.

6. The control apparatus according to claim 1, wherein in a case where the reception result indicates unsuccess of reception of the signal, the controller does not determine the radio communication-related parameter used by a terminal of the plurality of terminals, the terminal having transmitted the signal.

7. The control apparatus according to claim 1, wherein the controller determines a plurality of the radio communication-related parameters in descending order of priority.

8. A communication system, comprising:
a plurality of terminals; and
a control apparatus that performs centralized control of the plurality of terminals, wherein:
the control apparatus includes:
an acquirer that acquires a reception result for each of the plurality of terminals, the reception result indicating a result of reception processing on a first signal transmitted from a corresponding one of the plurality of terminals; and
a first controller that performs machine learning common to the plurality of terminals based on at least one of a plurality of the reception results and determines a radio communication-related parameter used by each of the plurality of terminals, and
each of the plurality of terminals includes:
a receiver that receives control information including the radio communication-related parameter from the control apparatus;
a second controller that performs transmission processing on a second signal by using the radio communication-related parameter; and
a transmitter that transmits the second signal.

9. The communication system according to claim 8, wherein in a case where the control information is not receivable, the second controller configures, based on the control information having been previously received, the radio communication-related parameter to be used in the transmission processing.

10. The communication system according to claim 9, wherein:
the control information includes a plurality of the radio communication-related parameters in descending order of priority, and
the second controller changes the radio communication-related parameter to one of the plurality of radio communication-related parameters included in the control information having been previously received.

11. The communication system according to claim 8, wherein the plurality of terminals and the control apparatus are applied to a low power wide area (LPWA) network.

12. A control method, comprising:
acquiring, by a controller that performs centralized control of a plurality of terminals, a reception result for each of the plurality of terminals, the reception result indicating a result of reception processing on a signal transmitted from a corresponding one of the plurality of terminals; and
performing, by the controller, machine learning common to the plurality of terminals based on at least one of a plurality of the reception results and determining a radio communication-related parameter used by each of the plurality of terminals.
